(19) United States
(12) Patent Application Publication
(10) Pub. No.: US 2025/0091659 A1
(43) Pub. Date: Mar. 20, 2025

(54) VEHICLE BOTTOM STRUCTURE

(71) Applicant: Honda Motor Co., Ltd., Tokyo (JP)

(72) Inventors: Keita ISHIHARA, Saitama (JP); Naoki TANI, Tokyo (JP); Yoshikatsu OTA, Saitama (JP); Yoshiro ISHINABE, Tokyo (JP)

(73) Assignee: Honda Motor Co., Ltd., Tokyo (JP)

(21) Appl. No.: 18/769,374

(22) Filed: Jul. 10, 2024

(30) Foreign Application Priority Data
Sep. 14, 2023 (CN) 202311186559.3

(51) Int. Cl. B62D 25/20; B60K 1/04; B62D 21/03

(52) U.S. Cl. CPC B62D 25/2036; B62D 21/03; B60K 2001/0438

(57) ABSTRACT

A vehicle bottom structure that may improve the rigidity of the vehicle body and suppress the height of the vehicle body floor is provided in the disclosure. The vehicle bottom structure includes a floor panel, a side beam, and a floor cross member. The side beam is disposed on an outer side of the floor panel in a vehicle width direction and extends toward a vehicle front-rear direction. The floor cross member extends along the vehicle width direction and has an end portion connected to the side beam. An outer end portion of the floor panel in the vehicle width direction is formed lower in a vehicle up-down direction than a center portion of the floor panel. The floor cross member is located above the floor panel in the vehicle up-down direction, and the floor cross member and the outer end portion are away from each other.

### CROSS-REFERENCE TO RELATED APPLICATION

This application claims the priority benefit of China application serial no. 202311186559.3 filed on Sep. 14, 2023. The entirety of the above-mentioned patent application is hereby incorporated by reference herein and made a part of this specification.

### BACKGROUND

### Technical Field

The disclosure relates to a vehicle bottom structure.

### Description of Related Art

In order to allow vulnerable groups such as the elderly, the disabled, and children to utilize sustainable transportation systems, we are committed to providing transportation tools with superior vehicular comfort. In the existing technology, a deformation area for absorbing collision force is provided in the vehicle bottom structure. The vehicle bottom structure is generally located at the upper and outer sides of the side beams. In this way, the height of the vehicle body floor near the floor cross member is formed to be higher and protruding. The disclosure aims to address the aforementioned issue for improving the rigidity of the vehicle body, thereby providing a sustainable transportation system.

### SUMMARY

A vehicle bottom structure that may improve the rigidity of the vehicle body and suppress the height of the vehicle body floor is provided in the disclosure.

The vehicle bottom structure of the disclosure includes a floor panel forming a vehicle compartment, a side beam, and a floor cross member. The side beam is disposed on an outer side of the floor panel in a vehicle width direction and extends toward a vehicle front-rear direction. The floor cross member extends along the vehicle width direction and has an end portion connected to the side beam. An outer end portion of the floor panel in the vehicle width direction is formed lower in a vehicle up-down direction than a center portion of the floor panel in the vehicle width direction. The floor cross member is located above the floor panel in the vehicle up-down direction, and the floor cross member and the outer end portion of the floor panel are away from each other.

Based on the above, in the vehicle bottom structure of the disclosure, the floor panel and the floor cross member are away from each other in the vehicle up-down direction near the side beam, thereby forming a crushing space for deformation and load absorption in the event of a side impact. Moreover, since the floor panel near the side beam sinks downward, a crushing space may still be formed without any change in the height of the floor cross member, thus suppressing the height of the vehicle body. Accordingly, the vehicle bottom structure of the disclosure may improve the rigidity of the vehicle body and suppress the height of the vehicle body floor.

In order to make the above-mentioned features and advantages of the disclosure comprehensible, embodiments accompanied with drawings are described in detail below.

### BRIEF DESCRIPTION OF THE DRAWINGS

FIG. 1 is a top schematic diagram of the vehicle bottom structure of an embodiment of the disclosure.

FIG. 2 is a cross-sectional diagram of the vehicle bottom structure of FIG. 1 along line A-A.

FIG. 3A is a partial side diagram of the side beam of the vehicle bottom structure of this embodiment.

FIG. 3B is an internal schematic diagram of the side beam of FIG. 3A.

FIG. 4 is a cross-sectional diagram of the vehicle bottom structure of FIG. 1 along line B-B.

FIG. 5 is a top schematic diagram of the power unit case of the vehicle bottom structure of this embodiment.

FIG. 6 is a cross-sectional diagram of the power unit case of FIG. 5 along line C-C.

FIG. 7 is a partial bottom schematic diagram of the vehicle bottom structure of this embodiment.

### DETAILED DESCRIPTION OF DISCLOSED EMBODIMENTS

In an embodiment of the disclosure, a lower surface of the side beam is joined to the floor panel, and an upper surface of the side beam is joined to the floor cross member.

In an embodiment of the disclosure, the outer end portion of the floor panel is provided with a bracket positioned distantly above in the vehicle up-down direction, and the bracket is formed on a lower surface of the floor cross member.

In an embodiment of the disclosure, the floor cross member includes a body portion and a fragile portion. The fragile portion is disposed at an end portion of the body portion in the vehicle width direction, and the fragile portion is away from the floor panel.

In an embodiment of the disclosure, the side beam includes an inner member. The inner member is formed by joining a cap-shaped inner outer component and a cap-shaped inner interior component to form an inner closed section, and the inner closed section overlaps the floor cross member in the vehicle width direction.

In an embodiment of the disclosure, the side beam further includes an outer member. The outer member covers the inner member. The inner member and the outer member form an inclined portion that inclines upward in the vehicle up-down direction when approaching a center pillar.

In an embodiment of the disclosure, multiple floor cross members are formed in the vehicle front-rear direction, and an upper end of the inclined portion is disposed between the floor cross members when viewed in the vehicle width direction.

In an embodiment of the disclosure, the floor panel includes a frame and a power unit case. The frame is disposed further outward than the power unit case in the vehicle width direction, and an upper surface of the frame is formed lower than an upper surface of the power unit case in the vehicle up-down direction. The frame is joined to a flange portion of the power unit case, the flange portion extends outward from the power unit case in the vehicle width direction.

In an embodiment of the disclosure, a battery member extending along the vehicle width direction is disposed inside the power unit case. A cross section of the battery member is formed into two vertical sides and a horizontal side connecting the two vertical sides, the horizontal side and the flange portion form a straight line in the vehicle width direction.

In an embodiment of the disclosure, the floor panel includes a frame and a power unit case. The frame is disposed further outward than the power unit case in the vehicle width direction, and an upper surface of the frame is formed lower than an upper surface of the power unit case in the vehicle up-down direction. The frame includes an upper frame and a lower frame, and the upper frame and the lower frame are joined to form a closed section. An inner end portion of the lower frame in the vehicle width direction is joined to the upper frame at a position away from the power unit case.

In an embodiment of the disclosure, the vehicle bottom structure further includes a lower support component. The lower support component is joined to a lower surface of the lower frame and a lower surface of the power unit case, and a length of the lower support component in the vehicle front-rear direction is less than a length of the lower frame in the vehicle front-rear direction.

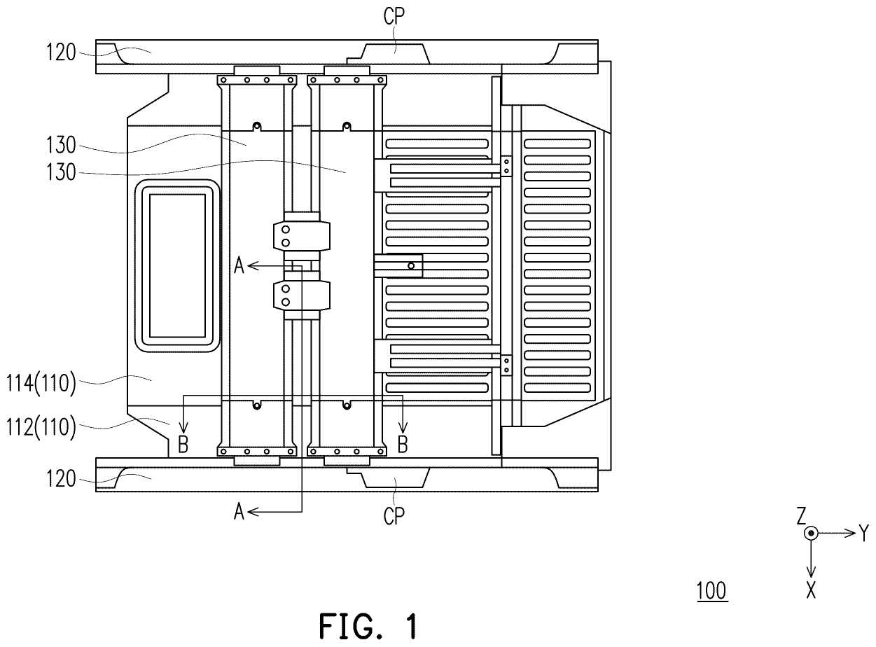

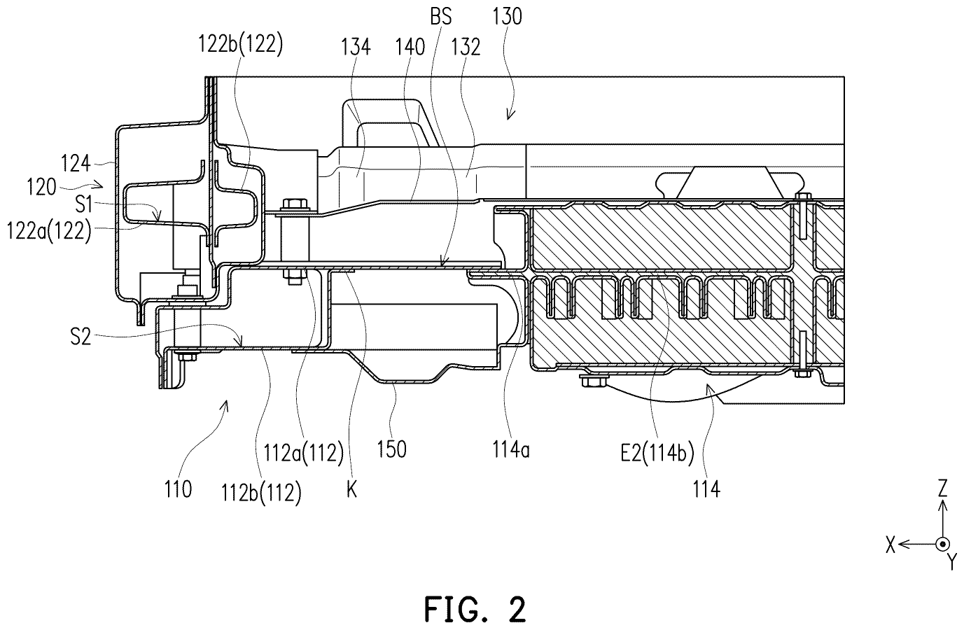

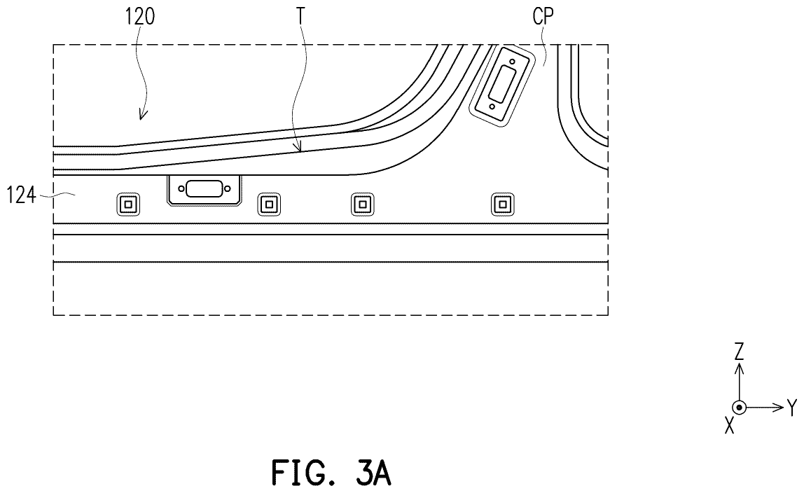

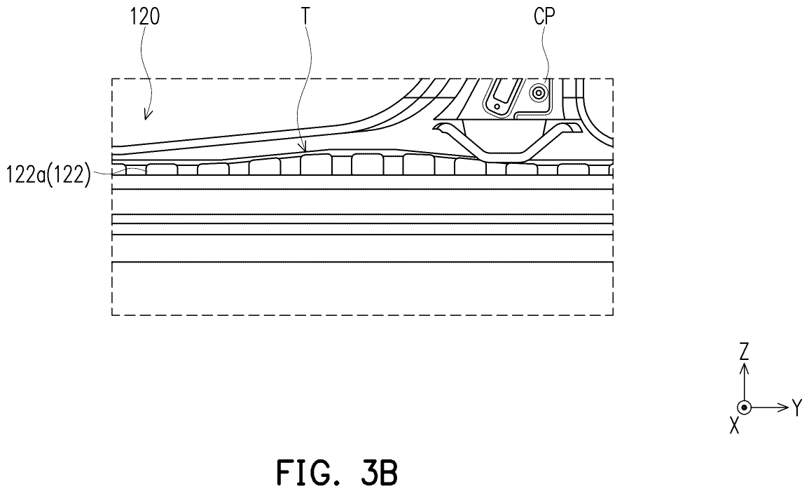

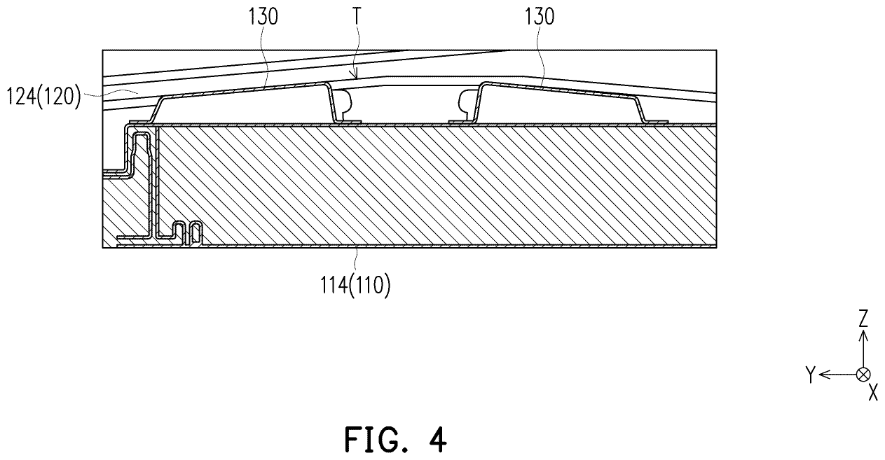

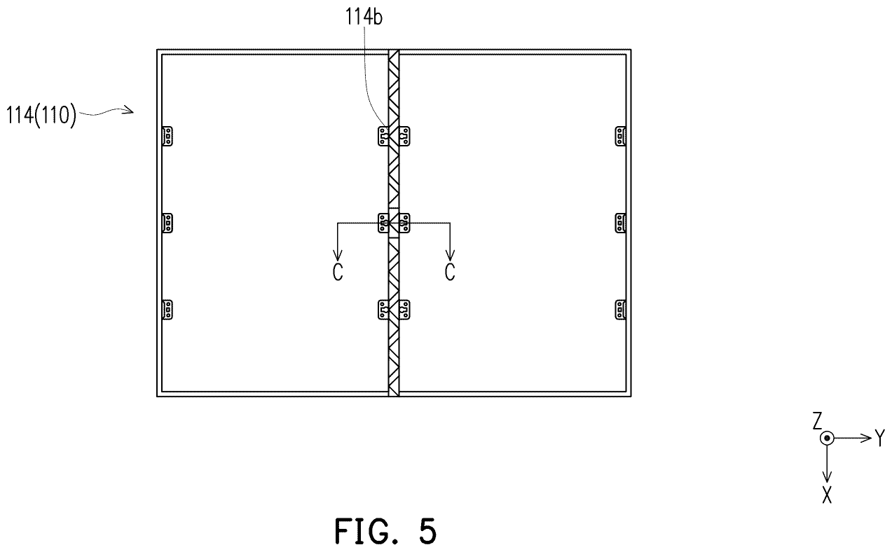

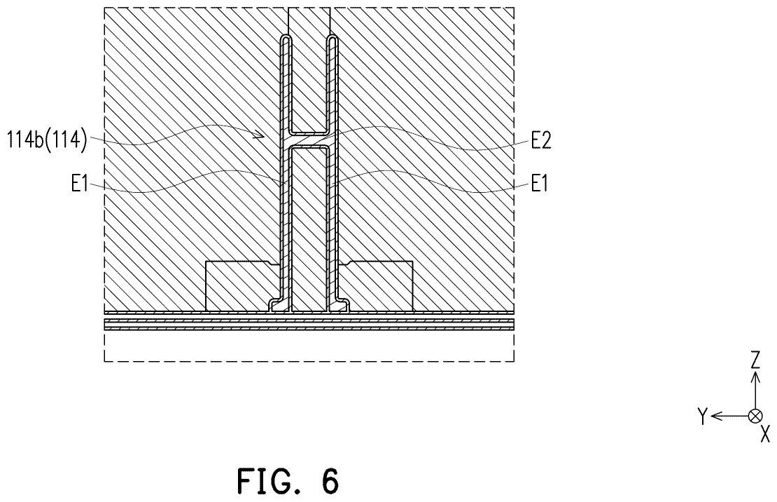

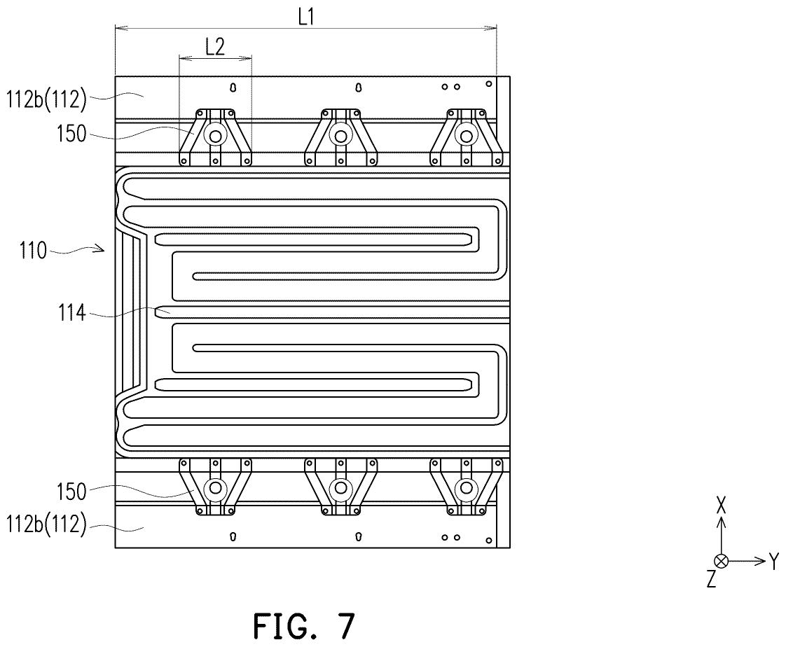

FIG. 1 is a top schematic diagram of the vehicle bottom structure of an embodiment of the disclosure. FIG. 2 is a cross-sectional diagram of the vehicle bottom structure of FIG. 1 along line A-A. FIG. 3A is a partial side diagram of the side beam of the vehicle bottom structure of this embodiment. FIG. 3B is an internal schematic diagram of the side beam of FIG. 3A. FIG. 4 is a cross-sectional diagram of the vehicle bottom structure of FIG. 1 along line B-B. FIG. 5 is a top schematic diagram of the power unit case of the vehicle bottom structure of this embodiment. FIG. 6 is a cross-sectional diagram of the power unit case of FIG. 5 along line C-C. FIG. 7 is a partial bottom schematic diagram of the vehicle bottom structure of this embodiment. In this embodiment, the vehicle bottom structure 100 is, for example, a bottom structure applied in ordinary passenger vehicles (not shown), but the disclosure is not limited thereto, and the bottom structure may also be applied to other types of vehicles. The vehicle width direction X, the vehicle front-rear direction Y, and the vehicle up-down direction Z in the drawings are not intended to limit the positional relationship of each component in the disclosure. In addition, it should be noted that, unless otherwise specified, the rear and upper directions used in the following specification are the directions pointed by the vehicle front-rear direction Y and the vehicle up-down direction Z arrows, and the front and bottom used in the specification are the opposite of the directions mentioned above. The inner side and outer side used in the specification are relative positions in the vehicle width direction X. The direction pointed by the arrow in the vehicle width direction X is not intended to limit the inner side or the outer side. If applicable, the same reference numerals in the drawings and the descriptions indicate the same or similar parts. The vehicle bottom structure 100 of this embodiment is described below with reference to FIG. 1 to FIG. 7.

Referring to FIG. 1, in this embodiment, the vehicle bottom structure 100 includes a floor panel 110, side beams 120, and floor cross members 130. The floor panel 110 forms a vehicle compartment (not shown). The vehicle compartment is located above the floor panel 110 in the vehicle up-down direction Z. However, as it is common knowledge, the disclosure does not further elaborate herein. The floor panel 110 may be divided into an outer end portion 112 located on the outer side and a center portion 114 located on the center side in the vehicle width direction X. The outer end portion 112 is a frame 112 to be described later, the center portion 114 is a power unit case 114 to be described later, and the center portion 114 is formed into a substantially flat surface. The side beams 120 are disposed on the outer side of the floor panel 110 in the vehicle width direction X and extend toward the vehicle front-rear direction Y. The floor cross member 130 extends along the vehicle width direction X and has an end portion connected to the side beam 120.

Furthermore, as shown in FIG. 2, the outer end portion 112 of the floor panel 110 in the vehicle width direction X is formed lower than the center portion 114 of the floor panel 110 in the vehicle width direction X in the vehicle up-down direction Z. That is, a step is formed between the outer end portion 112 and the center portion 114. The floor cross member 130 is disposed above the floor panel 110 in the vehicle up-down direction Z. The floor cross member 130 and the outer end portion 112 of the floor panel 110 are away from each other in the vehicle up-down direction Z to form a crushing space BS, and the floor cross member 130 and the center portion 114 of the floor panel 110 are close to each other in the vehicle up-down direction Z.

It may be seen from this that in the vehicle bottom structure 100 of this embodiment, the floor panel 110 and the floor cross member 130 are away from each other in the vehicle up-down direction Z near the side beam 120, thereby forming a crushing space BS for deformation and load absorption in the event of a side impact. Moreover, since the floor panel 110 near the side beam 120 sinks downward, a crushing space BS may still be formed without any change in the height of the floor cross member 130, thus suppressing the height of the vehicle body. Accordingly, the vehicle bottom structure 100 of this embodiment may improve the rigidity of the vehicle body and suppress the height of the vehicle body floor.

Furthermore, in this embodiment, a lower surface of the side beam 120 is joined to the floor panel 110, and an upper surface of the side beam 120 is joined to the floor cross member 130. More specifically, the lower surface of the outer member 124 of the side beam 120 is joined to the outer end portion 112 of the floor panel 110, and the upper surface of the outer member 124 of the side beam 120 is joined to the end portion of the floor cross member 130. By joining in a manner of sandwiching the side beams 120 from above and below, the load may be reliably transmitted to the outer end portion 112 and the floor cross member 130 in the event of a side impact, thereby ensuring deformation in the crushing space BS to absorb the impact.

Furthermore, in the present embodiment, the outer end portion 112 of the floor panel 110 is provided with a bracket 140 positioned distantly above in the vehicle up-down direction Z. The bracket 140 is formed on the lower surface of the floor cross member 130 to improve the rigidity of the floor cross member 130. Additionally, the floor cross member 130 includes a body portion 132 and a fragile portion 134. The fragile portion 134 is formed into a shape that is relatively easy to deform, such as a groove, and is disposed at an end portion of the body portion 132 in the vehicle width direction X, for example, an end portion near the outer side, but the disclosure is not limited thereto. The fragile portion 134 is away from the floor panel 110 (outer end portion 112) in the vehicle up-down direction Z. Therefore, in the event of an impact, the fragile portion 134 and the floor panel 110 are deformed respectively to absorb the impact, thereby improving the safety of the vehicle body.

Furthermore, in this embodiment, the side beam 120 includes an inner member 122 and an outer member 124. The inner member 122 is formed by joining, for example, a cap-shaped inner outer component 122a and a cap-shaped inner interior component 122b in the vehicle width direction X, thereby forming an inner closed section S1. The inner closed section S1 overlaps the floor cross member 130 in the vehicle width direction X. In this way, the rigidity of the side beam 120 may be enhanced to prevent the cross section from being crushed. The outer member 124 covers the inner member 122 and may also be formed by joining two cap-shaped components, but the disclosure is not limited thereto.

As shown in FIG. 3A and FIG. 3B, in this embodiment, the inner member 122 and the outer member 124 form an inclined portion T that inclines upward in the vehicle up-down direction Z when approaching a center pillar CP. As a result, the side surface is increased at the location (e.g., near the center pillar CP) that bears a large impact load, and the height of the side beam 120 in the vehicle up-down direction Z away from the center pillar CP may also be suppressed, to improve rigidity and passenger comfort when getting on and off the vehicle.

Preferably, as shown in FIG. 1 and FIG. 4, multiple floor cross members 130, such as two floor cross members 130, are formed in the vehicle front-rear direction Y, but the disclosure is not limited thereto. The upper end of the inclined portion T of the side beam 120 is disposed between the floor cross members 130 when viewed in the vehicle width direction X (i.e., in the viewing angle of FIG. 4). Since the seat (not shown) in the vehicle is installed on the floor cross member 130 through the seat bracket (not shown), and the seat is disposed at a position higher than the height of the side beam 120 in the vehicle up-down direction Z, in order to correspond to the height of the inclined portion T (the higher position in the side beam 120), the height of the floor cross member 130 needs to be raised, thereby increasing the cross section of the floor cross member 130 and improving the rigidity. Although FIG. 4 only illustrates the inclined portion T of the outer member 124, the position of the inclined portion T of the inner member 122 is substantially the same as the position of the inclined portion T of the outer member 124, and is not further illustrated herein.

Returning to FIG. 2, in this embodiment, the floor panel 110 includes a frame 112 and a power unit case 114. As mentioned above, the frame 112 is disposed further outward than the power unit case 114 in the vehicle width direction X, so that the frame 112 deforms after being hit by a side impact to reduce the deformation of the power unit case 114 located relatively on the inner side. In detail, the power unit case 114 is, for example, a case of an intelligent power unit (IPU), used to protect the intelligent power unit located therein. Furthermore, the power unit case 114 is assembled below the vehicle body frame (partially shown), the vehicle body frame is formed, for example, by the side beams 120, the front dash panel (not shown, e.g., a high-strength material such as heat-treated material), and the rear member (not shown). For example, the power unit case 114 is installed on the floor cross member 130, and is then installed on the side beam 120 through a connecting member (e.g., the frame 112). Water intrusion is prevented by sealing the vehicle body frame and the power unit case 114. In addition, the power unit case 114 is connected to the vehicle body frame by, for example, screws or bolts, but the disclosure is not limited thereto.

In addition, in this embodiment, the upper surface of the frame 112 is formed lower than the upper surface of the power unit case 114 in the vehicle up-down direction Z (i.e., formed as the aforementioned step). The frame 112 is joined to the flange portion 114a of the power unit case 114, in which the flange portion 114a extends outward from the power unit case 114 in the vehicle width direction X, and is connected to the frame 112 by screws or bolts, but the disclosure is not limited thereto. In this way, it is ensured that the load of a side impact is transmitted to the power unit case 114 through the frame 112, thereby improving the rigidity. Moreover, the upper surface connected to the frame 112 allows the floor panel 110 to deform more easily to absorb impact, thereby preventing the crushing space BS from being ineffective due to excessive rigidity. At the same time, after the frame 112 is connected to the power unit case 114, the number of parts may be reduced compared with the prior art to further ensure the internal space.

In addition, the frame 112 includes an upper frame 112a and a lower frame 112b. The upper frame 112a and the lower frame 112b are joined to form a closed section S2, and the inner end portion K of the lower frame 112b in the vehicle width direction X is joined to the upper frame 112 at a position away from the power unit case 114. By joining at a position away from the power unit case 114, the increase in rigidity in the crushing space BS may be reduced, and a certain rigidity difference is formed with the side beam 120 to allow the crushing space BS to deform more easily. In addition, the inner end portion K of the lower frame 112b is away from the power unit case 114 so that the support rigidity of the upper frame 112a is higher.

Referring to FIG. 2, FIG. 5, and FIG. 6, in this embodiment, a battery member 114b extending along the vehicle width direction X is disposed inside the power unit case 114. The battery member 114b is used to fix a power unit such as a battery (not shown) in the power unit case 114, and as shown in FIG. 6, the cross section of the battery member 114b is formed into two vertical sides E1 and a horizontal side E2 connecting the two vertical sides E1, and is similar to an H-shape. As shown in FIG. 2, the horizontal side E2 and the flange portion 114a form a straight line in the vehicle width direction X. In this way, the battery member 114b may withstand the load transmitted from the frame 112 and the power unit case 114 through the flange portion 114a, thereby improving the overall rigidity and suppressing deformation.

Referring to FIG. 1, FIG. 2, and FIG. 7, in this embodiment, the vehicle bottom structure 100 further includes a lower support component 150. As shown in FIG. 2, the lower support component 150 is joined to the lower surface of the lower frame 112 b and the lower surface of the power unit case 114 to further ensure that the power unit case 114 is supported by the frame 112. In addition, as shown in FIG. 7, the length L2 of the lower support component 150 in the vehicle front-rear direction Y is less than the length L1 of the lower frame 112b in the vehicle front-rear direction Y, so as to suppress the increase in rigidity caused by the overlap between the lower support component 150 and the crushing space BS, and to reduce the cross section of the lower support component 150 as much as possible.

To sum up, in the vehicle bottom structure of the disclosure, the floor panel and the floor cross member are away from each other in the vehicle up-down direction near the side beam, thereby forming a crushing space for deformation and load absorption in the event of a side impact. Moreover, since the floor panel near the side beam sinks downward, a crushing space may still be formed without any change in the height of the floor cross member, thus suppressing the height of the vehicle body. In addition, the frame (i.e., the outer end portion of the floor panel) is disposed further outward than the power unit case (i.e., the center portion of the floor panel) in the vehicle width direction, so that the frame deforms after being hit by a side impact to reduce the deformation of the power unit case located relatively on the inner side. Accordingly, the vehicle bottom structure of the disclosure may improve the rigidity of the vehicle body and suppress the height of the vehicle body floor.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A vehicle bottom structure, comprising:
a floor panel, forming a vehicle compartment;
a side beam, disposed on an outer side of the floor panel in a vehicle width direction and extending toward a vehicle front-rear direction; and
a floor cross member, extending along the vehicle width direction and having an end portion connected to the side beam, wherein
an outer end portion of the floor panel in the vehicle width direction is formed lower in a vehicle up-down direction than a center portion of the floor panel in the vehicle width direction,
the floor cross member is located above the floor panel in the vehicle up-down direction, and the floor cross member and the outer end portion of the floor panel are away from each other.

2. The vehicle bottom structure according to claim 1, wherein
a lower surface of the side beam is joined to the floor panel, and an upper surface of the side beam is joined to the floor cross member.

3. The vehicle bottom structure according to claim 1, wherein
the outer end portion of the floor panel is provided with a bracket positioned distantly above in the vehicle up-down direction,
the bracket is formed on a lower surface of the floor cross member.

4. The vehicle bottom structure according to claim 1, wherein
the floor cross member comprises a body portion and a fragile portion,
the fragile portion is disposed at an end portion of the body portion in the vehicle width direction, and the fragile portion is away from the floor panel.

5. The vehicle bottom structure according to claim 1, wherein
the side beam comprises an inner member, the inner member is formed by joining a cap-shaped inner outer component and a cap-shaped inner interior component to form an inner closed section, and
the inner closed section overlaps the floor cross member in the vehicle width direction.

6. The vehicle bottom structure according to claim 5, wherein
the side beam further comprises an outer member, the outer member covers the inner member, wherein
the inner member and the outer member form an inclined portion that inclines upward in the vehicle up-down direction when approaching a center pillar.

7. The vehicle bottom structure according to claim 6, wherein
a plurality of floor cross members are formed in the vehicle front-rear direction,
an upper end of the inclined portion is disposed between the floor cross members when viewed in the vehicle width direction.

8. The vehicle bottom structure according to claim 1, wherein
the floor panel comprises a frame and a power unit case, the frame is disposed further outward than the power unit case in the vehicle width direction, and an upper surface of the frame is formed lower than an upper surface of the power unit case in the vehicle up-down direction,
the frame is joined to a flange portion of the power unit case, the flange portion extends outward from the power unit case in the vehicle width direction.

9. The vehicle bottom structure according to claim 8, wherein
a battery member extending along the vehicle width direction is disposed inside the power unit case,
a cross section of the battery member is formed into two vertical sides and a horizontal side connecting the two vertical sides,
the horizontal side and the flange portion form a straight line in the vehicle width direction.

10. The vehicle bottom structure according to claim 1, wherein
the floor panel comprises a frame and a power unit case, the frame is disposed further outward than the power unit case in the vehicle width direction, and an upper surface of the frame is formed lower than an upper surface of the power unit case in the vehicle up-down direction,
the frame comprises an upper frame and a lower frame, and the upper frame and the lower frame are joined to form a closed section,
an inner end portion of the lower frame in the vehicle width direction is joined to the upper frame at a position away from the power unit case.

11. The vehicle bottom structure according to claim 10, further comprising a lower support component, wherein the lower support component is joined to a lower surface of the lower frame and a lower surface of the power unit case, and
a length of the lower support component in the vehicle front-rear direction is less than a length of the lower frame in the vehicle front-rear direction.
